(19) United States
(12) Patent Application Publication
(10) Pub. No.: US 2005/0232133 A1
(43) Pub. Date: Oct. 20, 2005

(54) Method of receiving and processing a multi-carrier signal and multi-carrier reception device employing the method

(76) Inventors: Wladimir Bocquet, Koto (JP); Yoshinori Tanaka, Kawasaki (JP)

Correspondence Address: KATTEN MUCHIN ROSENMAN LLP, 575 MADISON AVENUE, NEW YORK, NY, 10022-2585, US

(21) Appl. No.: 11/097,979

(22) Filed: Apr. 1, 2005

Related U.S. Application Data
(63) Continuation of application No. PCT/JP03/02565, filed on Mar. 5, 2003.

(51) Int. Cl. H04J 11/00

(52) U.S. Cl. 370/206

(57) ABSTRACT

A multi-carrier receiver which dispenses with a guard interval and avoids an influence of an intersymbol interference (ISI) based on the height of the guard interval. This multi-carrier receiver has a serial/parallel converter for receiving a multi-carrier signal to convert it into a parallel signal, a Fourier transformer for selecting a multi-carrier signal over a section longer than one symbol of the received multi-carrier signal from an output of the serial/parallel converter to subject the selected multi-carrier signal to discrete Fourier transform, a channel compensator for subjecting the Fourier transform signal to channel equalization, a matrix conveter for contracting the dimension of the signal of channel equalized signal down to the dimension of the received multi-carrier signal, a parallel/serial converter for converting the output of the matrix converter into a serial signal, and a demodulator for matching the output of the parallel/serial converter with the modulator on a transmitter side, and a decoder for matching it with an encoder.

### TECHNICAL FIELD

The present invention relates to a method of receiving and processing a multi-carrier signal and a multi-carrier reception device employing the method and in particular relates to intersymbol interference equalization of received data in a multi-carrier reception device.

### BACKGROUND ART

Techniques that are applied to multi-carrier communications systems include OFDM (Orthogonal Frequency Division Multiplexing) systems as disclosed in Non-patent Reference 1 listed below and MC-CDMA (Code Division Multiple Access) systems.

The OFDM system enables high bit rate transmission to be achieved using a plurality of mutually orthogonal narrow-band carriers.

Specifically, the frequency bandwidth is divided into small ranges and the respective divided ranges are processed using sub-carriers of low bit rate. The sub-carriers are not subject to frequency selective fading, so the multi-carrier modulation system is advantageous in respect of frequency selective fading.

In contrast, in the MC-CDMA system, the CDMA technique is employed for OFDM modulation as a multiple access multiplexing technique. The respective user data are spread in the frequency region using orthogonal spread spectrum code, and are multiplexed with other user data that is spread using a different spread spectrum code.

An outline layout of a transmission device and reception device employing the conventional systems described above is as follows.

Specifically, FIG. 1 is an example of the layout of a MC-CDMA transmission device employing a prior art system as described above, in which a MC-CDMA transmission signal is generated and transmitted.

In FIG. 1, binary data 1 is encoded using an encoder 2 of prescribed bit length and is modulated by a modulator 3 using a modulation system such as BPSK, QPSK or 16-QAM corresponding to the encoding. The modulated data is converted to Np1 data symbols using a serial/parallel converter 4.

Np1 data symbols are simultaneously processed, a single data symbol being copied to a data set by a copier 5 using a spreading factor (SF). In this case, the transmission device transmits data using a number Np1*SF of sub-carriers. Data i.e. orthogonal code of length SF is multiplexed by a chip provided for each sub-carrier.

The MC-CDMA transmission device spreads the signal in the frequency region using spreading code 6 and the inverse fast Fourier transformer (IFFT) 7 then performs inverse fast Fourier transformation with a number of dimensions equal to (Np1*SF). These are the main characteristics of an MC-CDMA system.

In addition, the data set is converted to serial data by the parallel/serial converter 8 and, in order to remove intersymbol interference, an insertion section 8 inserts guard intervals GI.

FIG. 2 shows the layout of a MC-CDMA reception device corresponding to the MC-CDMA transmission device of FIG. 1 using the prior art described above.

In FIG. 2, first of all the guard intervals inserted at the transmission end are removed from the reception data by means of a removal section 9. The data from which the guard intervals GI have thus been removed is converted to a parallel signal by means of a serial/parallel converter 10 and subjected to discrete Fourier transformation by a fast Fourier transformer 11. At this point, a channel compensator 13 deduces the channel characteristics of the sub-carriers from pilot symbols.

Next, using a combining method such as for example orthogonal restoring combining (ORC), equal gain combining (EGC), maximum ratio combining (MRC), or minimum mean square error combining (MMSEC), the combining coefficients are multiplied with the output of the fast Fourier transformer 11 and code 12 that is the same as the spread spectrum code at the transmission end is multiplied therewith.

After having been subjected to this channel compensation, the output of the fast Fourier transformer 11 is accumulated in an accumulation section 14 matched with the intervals of the spreading factor (SF) of the frequency region, corresponding to the copying of the data sets in accordance with the spreading factor (SF) at the transmission end. The data symbols specific to a single user are thereby extracted.

In addition, the signals accumulated by the accumulation section 14 are converted to serial signals by a parallel/serial converter 15, demodulated by a demodulator 16 and decoded by a decoder 17.

FIG. 3 and FIG. 4 are respectively examples of the layout of an OFDM transmission device and reception device as employed in the conventional systems described above; they differ from the layout of the MC-CDMA transmission device of FIG. 1 in that the spread spectrum processing using spread spectrum code and the inverse spread spectrum processing in the reception device are not performed. The rest of the layout is the same as that of the MC-CDMA transmission device and reception device shown in FIG. 1 and FIG. 2 so further description thereof is dispensed with.

Non-Patent Reference 1

R. Van Nee and R. Prasad, “OFDM For Wireless Multimedia Communications”, Artech House Publishers, 2000

### DISCLOSURE OF THE INVENTION

In the prior art example described above, the OFDM transmission system is effective in regard to multi-path propagation and circuit distortion, but, in the extreme case, the maximum propagation delay becomes greater than the length of the guard intervals GI and, in the case where an adjacent symbol is affected by a preceding symbol i.e. in the case where intersymbol interference (ISI) occurs, is insufficient.

An object of the present invention is therefore to provide a multi-carrier reception processing method that avoids such problems and a multi-carrier reception device using this.

A first mode of achieving the above object of the present invention is characterized in that a multi-carrier signal in a multi-carrier system is received, a multi-carrier signal of an interval longer than one symbol of said received multi-carrier signal is selected, discrete Fourier transformation is performed on said selected multi-carrier signal, channel equalization is performed on said signal that has been subjected to said discrete Fourier transformation, and the dimensions of said channel-equalized signal are reduced to the dimensions of said received multi-carrier signal.

A second mode of achieving the above object of the present invention is characterized in that, in the first mode, selection of said multi-carrier signal of interval longer than one symbol is performed in order to execute discrete Fourier transformation of greater length than the dimensions of said received multi-carrier signal.

A third mode of achieving the above object of the present invention is characterized in that, in the first mode, said channel equalization is performed by multiplying the multi-carrier signal by equalization coefficients and in that the channel distortion effect of said received multi-carrier signal in the frequency region is thereby reduced.

A fourth mode of achieving the above object of the present invention is characterized in that, in the first mode, orthogonal frequency division multiplexing is employed in said multi-carrier system.

A fifth mode of achieving the above object of the present invention is characterized in that, in the first mode, multi-carrier code division multiple access is employed in said multi-carrier system.

A sixth mode of achieving the above object of the present invention is characterized in that, in any of the first to the fifth modes, said received multi-carrier signal does not include guard intervals between adjacent symbol frames.

Furthermore, a seventh mode of achieving the above object of the present invention is characterized in that, in the second mode, the discrete Fourier transformation of greater length than the dimensions of the multi-carrier signal is of a length which is an integral multiple of the dimensions of said multi-carrier signal.

Also, an eighth mode of achieving the above object of the present invention is characterized in that, in the seventh mode, an estimated value of the channel response with respect to said discrete Fourier transform output for each channel is found by interpolation of estimated values of reduced dimensions.

Further characteristics of the present invention will become clear from the embodiments of the invention described below with reference to the drawings.

### BRIEF DESCRIPTION OF THE DRAWINGS

FIG. 1 is an example layout of a MC-CDMA transmission device employing a prior art system;

FIG. 2 is an example layout of a MC-CDMA reception device corresponding to the MC-CDMA transmission device of FIG. 1;

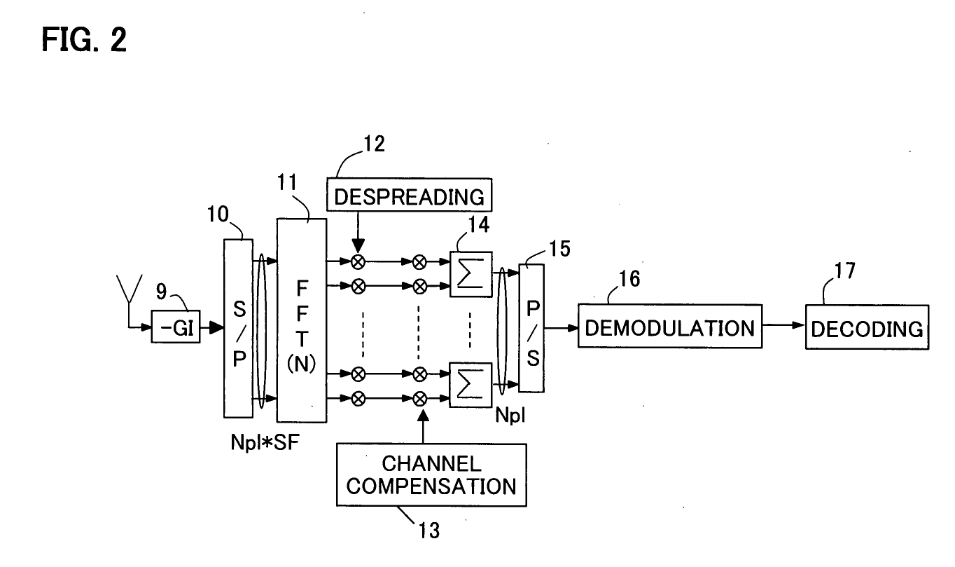

FIG. 3 is an example layout of an OFDM transmission device employing a prior art system;

FIG. 4 is an example layout of an OFDM reception device employing a prior art system;

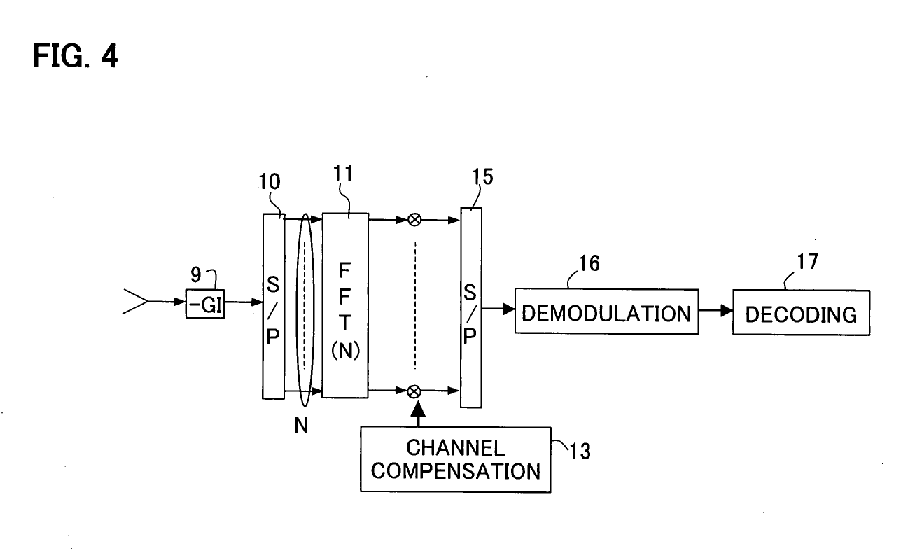

FIG. 5 is a block diagram of an example layout of an OFDM reception device according to the present invention;

FIG. 6 is a flow chart given in explanation of the flow of processing corresponding to the example layout of an OFDM reception device according to FIG. 5;

FIG. 7 is an example layout of a transformation matrix 111;

FIG. 8 is a view showing the layout of 2 N linked point clusters in the case where guard intervals are present;

FIG. 9 is a view showing a frame layout in the case where a pilot symbol is inserted in a transmission frame in a transmission device;

FIG. 10 is a view showing the layout of an embodiment of a reception device in the case of MC-CDMA when guard intervals are not employed;

FIG. 11 is a view showing the layout of an embodiment of a 2 N fast Fourier transformer (FFT) in the reception device layout of FIG. 10; and

FIG. 12 shows the layout of an embodiment of a fast Fourier transformer (FFT) 110 in the case where the principle of 2 N dimensions fast Fourier transformation is further extended to 4 N dimensions.

### DESCRIPTION OF THE PREFERRED EMBODIMENTS

Embodiments of the present invention are described below with reference to the drawings.

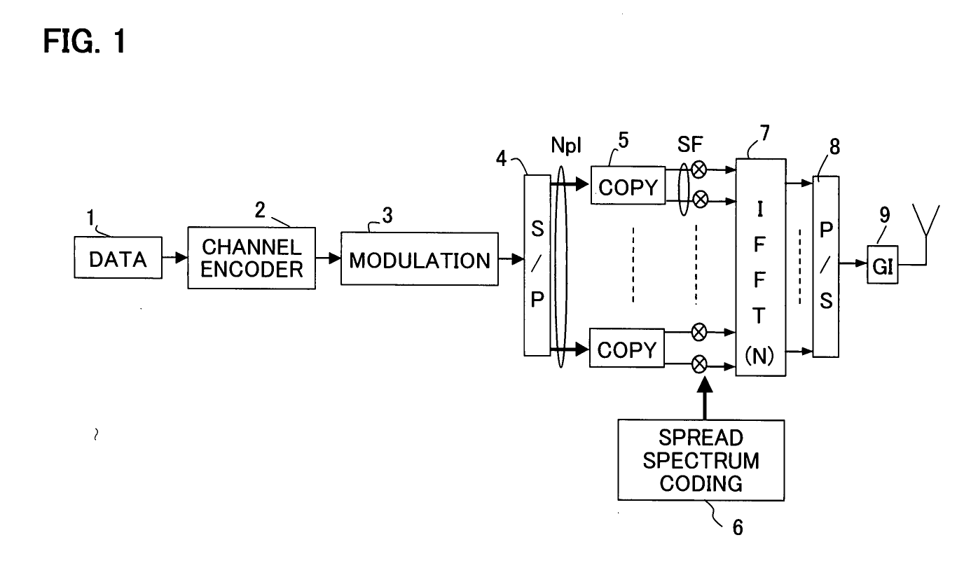

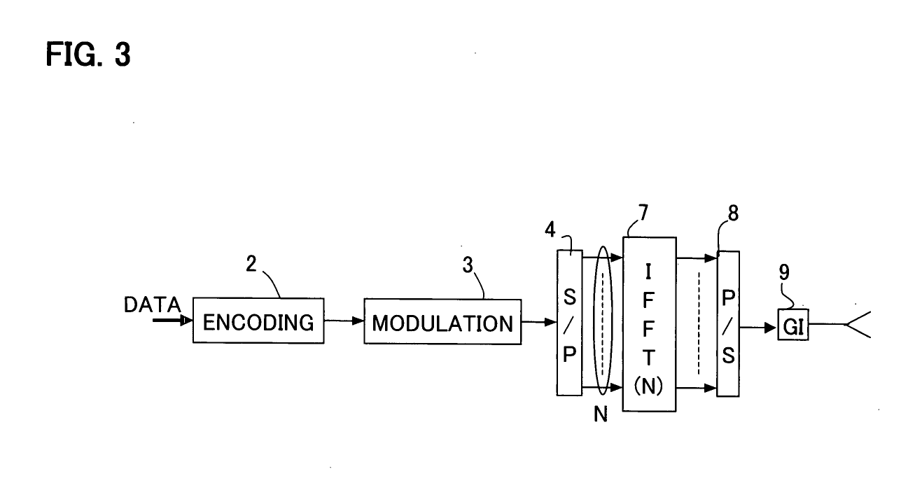

In application of a multi-carrier reception device according to the present invention, the corresponding transmission device that is employed may have a layout as in the prior art layout shown in FIG. 1 and FIG. 3. Furthermore, as will be described later, as the multi-carrier reception device according to the present invention, a reception device may be employed that is capable of being applied also to reception of signals in which no guard intervals GI are inserted at the transmission end.

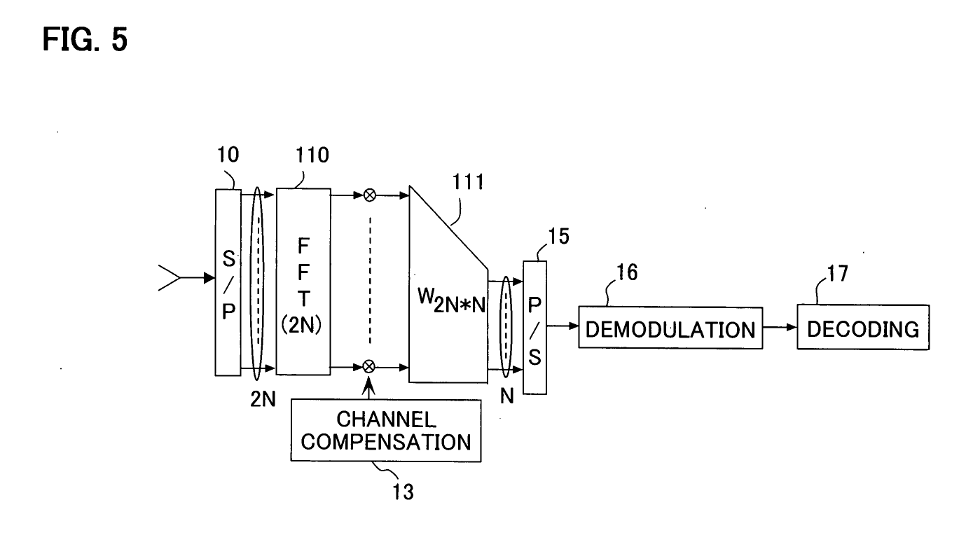

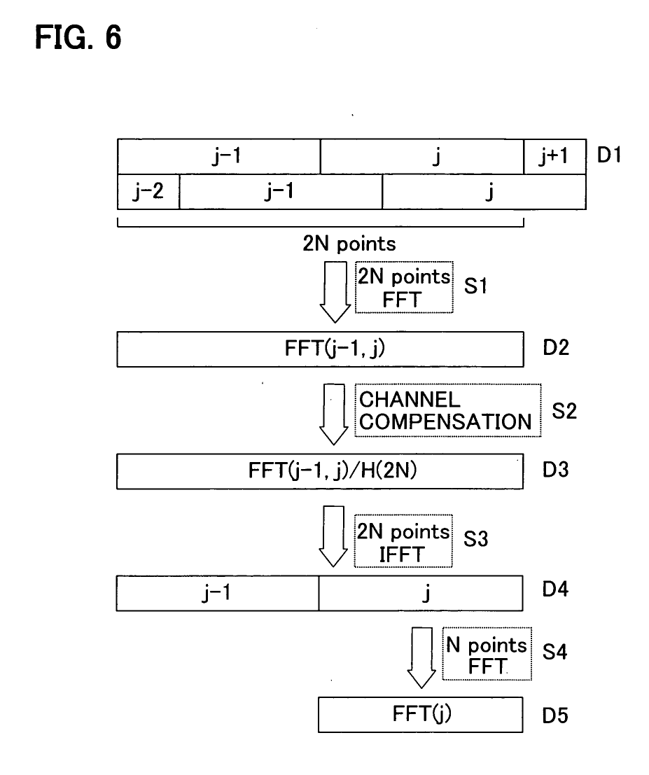

FIG. 5 is a block diagram of an example layout of an OFDM reception device according to the present invention. FIG. 6 is a flow chart given in explanation of the flow of processing corresponding to the example layout of the OFDM reception device of FIG. 5; an outline of the necessary processing for equalization compensation of channel distortion, omitting the intersymbol interference (ISI) portion, is shown.

It should be noted that, in the description below, the OFDM symbol length N is assumed to be much longer than the maximum amount of delay (expressed by τₘₐₓ) from the channel model.

In FIG. 5, the received signal train is first of all converted to a parallel signal by the serial/parallel converter 10. According to a characteristic feature of the present invention, as an embodiment, 2 N data symbols are found from this parallel signal using a window (j−1, j) of size 2 N points, from two continuous symbol frames (see D1, FIG. 6).

FIG. 6 shows how 2 N data symbols are successively found from two continuous symbol frames. Specifically, this Figure shows how 2 N data symbols are found from the (j−1)-th OFDM symbol frame and the j-th OFDM symbol frame and how 2 N data symbols are found from the j-th OFDM symbol frame and the (j+1)-th OFDM symbol frame.

When complete synchronization is achieved, only the two symbols of timing i and i−1 are subjected to data processing in the interval [iN; (i+1)N].

Discrete Fourier transformation of such 2 N data symbols is performed (step S1) by fast Fourier transformation processing performed by a 2 N point fast Fourier transformer 110, the construction of an embodiment of which is described later.

Next, channel compensation is performed by a distortion compensator 13 on the data (D2) that has been subjected to discrete Fourier transformation, in respect of each sub-carrier, in order to decrease channel distortion (step S2). After this, the dimensions of the signal are reduced using a special transformation matrix 111, prior to demodulation using a demodulator 16.

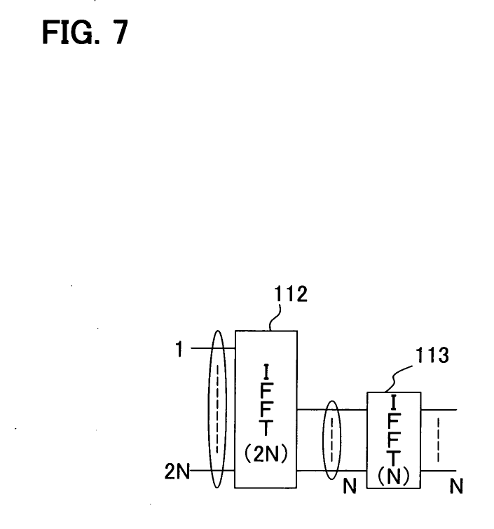

FIG. 7 shows an example layout of this transformation matrix 111. As an embodiment, this comprises an inverse fast Fourier transformer (IFFT) 112 in respect of the 2 N points and a second IFFT 113 that, of the transformation processing output of the IFFT 112, performs inverse discrete Fourier transformation in respect of the subordinate N points.

The inverse fast Fourier transformer (IFFT) 112 performs (step S3) inverse discrete Fourier transformation using inverse fast Fourier transformation on the channel-compensated data (D3). Next, of the inverse discrete Fourier transformed data D4, inverse discrete Fourier transformed data D5 is obtained by performing an inverse discrete Fourier transformation (step S4) using the second IFFT 113, solely in respect of N points. In this way, the 2 N dimensions of the reception data are reduced to N dimensions.

Next, in FIG. 5, the reception data of N dimensions is converted to a serial signal by the parallel/serial converter 15 and is then subjected to demodulation using a demodulator 6 corresponding to the modulator 3 (see FIG. 1) at the transmission end and decoding using a decoder 17 corresponding to the channel encoder 2.

Summarizing the above processing performed by the reception device, the principle of the present invention is that, in order to reduce the effect of intersymbol interference (ISI), the length on which fast Fourier transformation i.e. discrete Fourier transformation is performed is extended. In a multi-carrier reception device, the effect of the preceding OFDM symbol can be moderated by finding the 2 N point fast Fourier transform (FFT).

Further description of the processing in an OFDM reception device will now be given using numerical equations, in order to substantiate the utility of the present invention. It should be noted that although, hereinbelow, a description is given of the case where no guard intervals GI are inserted, subsequent application of the present invention is possible whether guard intervals GI are inserted or not.

In application of the present invention, the OFDM symbol length is assumed to be much larger than the amount of delay spreading, so only the residual portions of the received signals represent a combination of two continuous transmission symbols.

In this case, the reception signal rₖ⁽ⁱ⁾ is represented as the following expression 1.

$${r}_{k}^{( i )} = \{ \begin{matrix} {\sum }_{p = 0}^{P - 1} {h}_{p} \cdot {x}_{k - {τ}_{p}}^{( i )} + {\sum }_{p = P}^{{P}_{max} - 1} {h}_{p} \cdot {x}_{N - {τ}_{p} + k}^{( i - 1 )} + {\tilde{n}}_{k}^{( i )} & ∀ 0 \leq k < {τ}_{{p}_{Max}} \\ {\sum }_{p = 0}^{{P}_{max} - 1} {h}_{p} \cdot {x}_{k - {τ}_{p}}^{( i )} + {\tilde{n}}_{k}^{( i )} & ∀ {τ}_{{P}_{Max}} \leq k < N\end{matrix} \qquad ( 1 )$$

As described above, the basis of the present invention is that intersymbol interference is moderated by equalization using extension of the discrete Fourier transformation length instead of canceling intersymbol interference.

If a symbol of the received signal is

$${{r}^{->}}^{( i )} = {[ {r}_{0}^{( i )} … {r}_{k}^{( i )} … {r}_{N - 1}^{( i )} ]}^{T}$$

the signal of two continuous symbol frames is expressed by \vec{y}⁽ⁱ⁾=[\vec{r}⁽ⁱ⁻¹⁾⁾\vec{r}⁽ⁱ⁾]

In order to clarify the description, the description will be given dividing the processing of the constituent portions of the multi-carrier reception device according to the present invention into three steps.

First Step [Extended Discrete Fourier Transform (Discrete Fourier Transform) Calculation]

From the signal \vec{y}⁽ⁱ⁾=[\vec{r}⁽ⁱ⁻¹⁾⁾\vec{r}⁽ⁱ⁾] of two continuous symbol frames,

$${Y}_{m}^{( i )} = β {\sum }_{k = 0}^{2 \cdot N - 1} {y}_{k}^{( i )} \cdot {ⅇ}^{- j \frac{π}{N} \cdot k \cdot m} \\ i . e . \\ {Y}_{m}^{( i )} = β {\sum }_{k = 0}^{N - 1} {r}_{k}^{( i - 1 )} \cdot {ⅇ}^{- j \frac{π}{N} \cdot k \cdot m} + β {\sum }_{k = N}^{2 \cdot N - 1} {r}_{k - N}^{( i )} \cdot {ⅇ}^{- j \frac{π}{N} \cdot k \cdot m} \qquad ( 2 )$$

is obtained.
furthermore, by combining expression 1 and expression 2, \vec{Y}⁽ⁱ⁾={double overscore (H)}_{2N*2N·}[\vec{X}⁽ⁱ⁻¹⁾\vec{X}⁽ⁱ⁾] is obtained, where

$${{Y}^{->}}^{( i )} = [ {Y}_{0}^{( i )} … {Y}_{2 N - 1}^{( i )} ] , {{X}^{->}}^{( i )} = [ {X}_{0}^{( i )} … {X}_{N - 1}^{( i )} ]$$
and {double overscore (H)}_{2N*2N} is the response of the channels of 2 N dimensions in the frequency region.

Second Step (Channel Distortion Compensation)

Let us assume that the matrix representation of the channel equalization coefficient is {double overscore (G)}_{2N*2N}.

Since the reception device estimates that there is no carrier-correlated interference, {double overscore (G)}_{2N*2N} is a diagonal matrix constituted by complex numbers.

The channel distortion compensation is expressed as follows in the frequency region.
\vec{V}⁽ⁱ⁾={double overscore (G)}_{2N*2N·}\vec{Y}⁽ⁱ⁾

Consequently, \vec{V}⁽ⁱ⁾={double overscore (G)}_{2N*2N·}{double overscore (H)}_{2N*2N·}[\vec{X}⁽ⁱ⁻¹⁾\vec{X}⁽ⁱ⁾]

Third Step (Reducing the Data Dimensions)

After channel distortion compensation, reduction of the data dimensions in the frequency region is necessary in order to equalize the dimensions with the dimensions of the reception data.

In order to implement this, the 2 N point signal is transformed to an N point signal stream by a special transformation matrix (transformation matrix 111 shown in FIG. 5).

The transformation matrix 111 is set as

$${\overline{\overline{W}}}_{2 {N}^{*} N} = {[ {w}_{p , k} ]}_{{0 \leq p < N}_{0 \leq k < 2 N}}$$

where β is a normalization coefficient

$${w}_{p , k} = β {\sum }_{m = 0}^{N - 1} {ⅇ}^{- j \frac{2 π}{N} p \cdot m} \cdot {ⅇ}^{j \frac{2 π}{N} ( m + N ) \cdot k}$$

When this expression is simplified, it becomes

$${w}_{p , k} = \{ \begin{matrix} β \cdot {( - 1 )}^{k} & if \frac{k}{2} - p = 0 \\ β \cdot {( - 1 )}^{k} \cdot \frac{1 - {ⅇ}^{j \cdot 2 \cdot π \cdot ( \frac{k}{2} - p )}}{1 - {ⅇ}^{j \frac{2 π}{N} \cdot ( \frac{k}{2} - p )}} & if \frac{k}{2} - p \neq 0\end{matrix} \qquad ( 3 )$$

The reception data found by processing using the above transformation matrix 111 is
\vec{\hat{X}}⁽ⁱ⁾={double overscore (W)}_{2N*N·}\vec{V}⁽ⁱ⁾
where, if guard intervals G1 are present, the selection of symbol blocks must be specified such that continuity between samples is maintained (i.e. orthogonality in the frequency region).

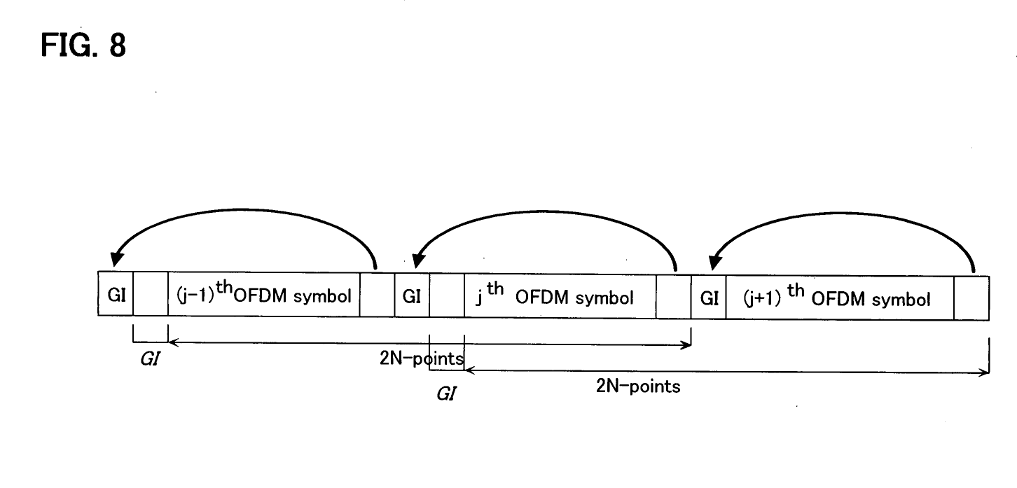

FIG. 8 is a view showing a 2 N continuous point cluster arrangement in the case where guard intervals GI are present. The thick arrows in the Figure indicate the arrangement of the guard intervals GI. 2 N points are obtained by combining the (j−1)-th OFDM symbol frame and the (j)-th OFDM symbol frame. A further 2 N points are obtained by combining the (j)-th OFDM symbol frame and the (j+1)-th OFDM symbol frame.

Next, the layout of an embodiment in a multi-carrier reception device to which the basic layout of the present invention as described above is applied is described.

First embodiment (estimation of channel response in respect of OFDM modulation system not having guard intervals GI):

In order to correctly estimate the channel response (circuit characteristics) in an N point frequency region, it is possible to multiplex pilot symbols with the transmission data in the transmission device.

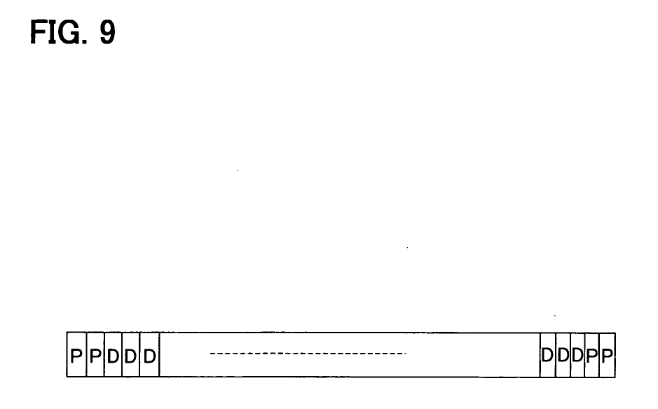

FIG. 9 shows an example of a frame in such a case. Specifically, the two OFDM symbols (represented by P) of the head and the tail of each frame are pilot symbols recognized at the reception end.

In order to estimate the channel response in the frequency region at the reception device, first of all, the channel compensation circuit 13 effects conversion to signals of the frequency region using N point fast Fourier transformation. It then estimates the channel response in respect of each sub-carrier for compensation of distortion, using the pilot symbols.

The compensation coefficients based on the estimated channel response are then multiplied with the outputs of the 2 N dimensional fast Fourier transformer 110.

However, in this case, over-sampling of the channel response corresponding to the layout of the present invention whereby the 2 N point channel response is obtained is necessary. However, different methods may also be used. For example, a 2 N point channel response can be obtained by averaging from the estimated values obtained by interpolation as described next i.e. with N dimensions.

Specifically, in the frequency region, taking the channel response in respect of the N dimensions as hₘ and taking the channel response in respect of the 2 N dimensions as gₘ, these may be expressed by the following expression 4.

$$\{ \begin{matrix} {g}_{2 m} = {h}_{m} & 0 \leq m < N \\ {g}_{2 m - 1} = \frac{{h}_{m - 1} + {h}_{m}}{2} & 1 \leq m < N\end{matrix} \qquad ( 4 )$$

A more specific description will now be given. Taking the reception signal as Y, taking into account the channel response, the reception signal Y may be expressed as follows with respect to the sub-carriers in the frequency region:
Y=H·X+N
where H is the channel distortion, X is the transmission signal and N is noise.

In the time region, this may be equivalently represented as follows.
y=h*x+n
where y, h, x and n are respectively the reception signal in the time region, the channel distortion, the transmission signal and noise. Also, * is a convolution operator.

The pilot series is subjected to inverse fast Fourier transformation at the transmission end and is received through a circuit (channel) at the reception end, where the corresponding fast Fourier transformation is performed. Taking the pilot series that is multiplexed with the data as being X1 in the transmission region, the channel response H1 is estimated by the following expression:
H1=Y/X1

The channel response in respect of the 2 N point frequency region can therefore be obtained (see expression 4 or above) by interpolation. Finally, the compensation coefficients in respect of the various sub-carriers can be found from the estimated values of the channel response.

Second embodiment (MA/CDMA with no guard intervals):

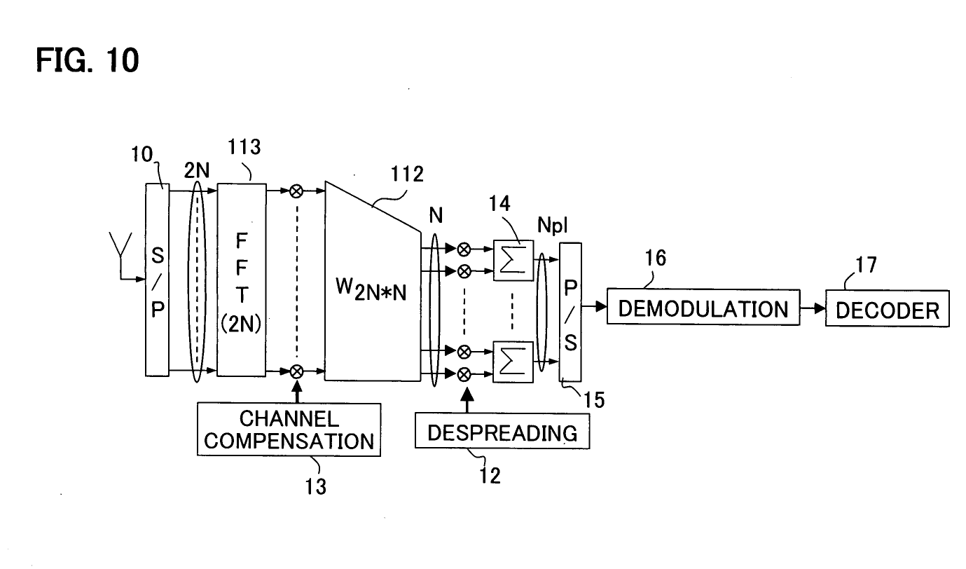

An embodiment of the layout of a reception device constituting a multi-carrier reception device according to the present invention in the case of MC-CDMA accompanying channel encoding and in which no guard intervals are employed is shown in FIG. 10. The prior art layout (FIG. 1) may be employed at the transmission device end.

As described above, equalization processing is performed in three steps.

Specifically, first of all, the fast Fourier transformer (FFT) 110 performs 2 N dimensional discrete Fourier transformation of length longer than a single MC-CDMA symbol on the FFT reception signal. Next, the channel compensator 13 multiplies the output of the FFT transformer 110 by the equalization coefficients found from the channel estimated values.

Next, after equalization, using the transformation matrix 111 indicated in expression 3 given above, the dimensions of the signal are made equal to the N dimensions of the received MC-CDMA symbols.

Finally, specific data symbols of a single user are extracted by accumulating in an accumulator 14 data that has been despread by despreading code 12, over the SF chip interval in the frequency region.

Third embodiment (fast Fourier transform of length longer than N in respect of OFDM modulation, without guard intervals):

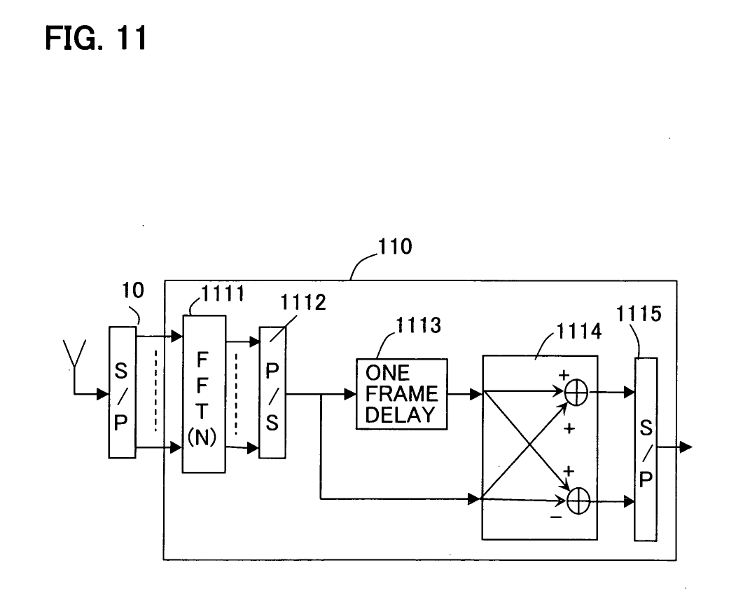

The layout of an embodiment of the 2 N fast Fourier transformer (FFT) 110 in the reception device layout of FIG. 10 is shown in FIG. 11.

Reception data is converted to a parallel signal by the serial/parallel converter 10 and N point discrete Fourier transformation is then performed on N points by a fast Fourier transformer 1111. A serial data series is then obtained by a parallel/serial converter 112 in respect of these data that have been subjected to transformation processing.

Furthermore, in order to calculate a 2 N point discrete Fourier transform, two continuous data series are obtained using a butterfly pattern (isomorphic mapping) 1114. Specifically, the output of the fast Fourier transformer 1111 is directly output together with the output of the fast Fourier transformer 1111 to which a delay of one frame has been added by a delay element 1113, to the butterfly pattern (isomorphic mapping) 1114.

In this way, it is possible to synchronies two continuous sets of reception data. The two outputs of the butterfly pattern (isomorphic mapping) 1114 are then converted to parallel by a serial/parallel converter 1115 and output.

Although, in the above description, the case was illustrated of performing discrete Fourier transformation on 2 N points in respect of two frames, application of the present invention is not restricted to this and in fact further extension is possible to employ a larger number of continuous frames.

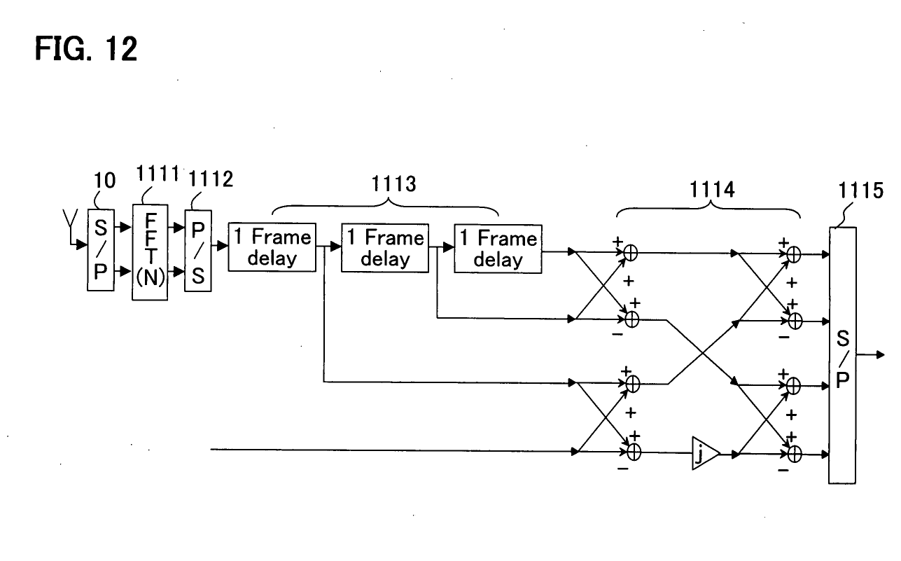

FIG. 12 shows the layout of an embodiment of the fast Fourier transformer (FFT) 110 in such a case of extension to 4 N dimensions. The butterfly pattern 1114 is implemented by performing synchronization by delay of three frames, performed by the frame delay element 1113. The portion indicated by j in the butterfly pattern 1114 of FIG. 12 indicates the square root of “−1”.

It should be noted that the transformer 111 corresponding to the fast Fourier transformer (FFT) 110 of FIG. 12 needs to have a matrix of W4N*N so as to provide 4 N inputs.

### INDUSTRIAL APPLICABILITY

As described above, according to the present invention, it is possible to provide a multi-carrier reception device wherein guard intervals are unnecessary and in which the effect of intersymbol interference (ISI) due to the length of the guard intervals can be avoided.

1. A method of reception processing of a multi-carrier signal comprising the steps of:
receiving a multi-carrier signal in a multi-carrier communications system;
selecting a multi-carrier signal of an interval longer than one symbol of said received multi-carrier signal;
performing discrete Fourier transformation on said selected multi-carrier signal;
performing channel equalization on said discrete Fourier transformed signal; and
reducing the dimensions of said channel equalized signal to the dimensions of said received multi-carrier signal.

2. The method of reception processing of a multi-carrier signal according to claim 1, wherein selection of said multi-carrier signal of an interval longer than one symbol is performed in order to execute discrete Fourier transformation of length longer than the dimensions of said received multi-carrier signal.

3. The method of reception processing of a multi-carrier signal according to claim 1, wherein said equalization is conducted by multiplying equalization coefficients by the multi-carrier signal so as to reduce the channel distortion effect of said received multi-carrier signal in the frequency region.

4. The method of reception processing of a multi-carrier signal according to claim 1, wherein orthogonal frequency division multiplexing is employed in said multi-carrier communications system.

5. The method of reception processing of a multi-carrier signal according to claim 1, wherein multi-carrier code division multiple access is employed in said multi-carrier communications system.

6. The method of reception processing of a multi-carrier signal according to claim 1, wherein said received multi-carrier signal does not include guard intervals between adjacent symbol frames.

7. The method of reception processing of a multi-carrier signal according to claim 2, the discrete Fourier transformation of length longer than the dimensions of the multi-carrier signal is of a length which is an integral multiple of the dimensions of said multi-carrier signal.

8. The method of reception processing of a multi-carrier signal according to claim 7, the estimated value of the channel response with respect to said discrete Fourier transformed output of each channel is found by interpolating estimated values of reduced dimensions.

9. A reception device for a multi-carrier signal in a multi-carrier system, comprising:
a serial/parallel converter that receives a multi-carrier signal and converts this to a parallel signal;
a Fourier transformer that selects a multi-carrier signal of an interval of length longer than one symbol of said received multi-carrier signal from the output of said serial/parallel converter and performs discrete Fourier transformation on said selected multi-carrier signal;
a channel compensator that performs channel equalization on said discrete Fourier transformed signal;
a matrix transformer that reduces the dimensions of said channel equalized signal to the dimensions of said received multi-carrier signal;
a parallel/serial converter that converts the output of said matrix transformer to a serial signal; and
a demodulator corresponding to the modulator and a decoder corresponding to the encoder at the transmission device side for the output of said parallel/serial converter.

10. The reception device for a multi-carrier signal according to claim 9, wherein the length of the discrete Fourier transformation in said Fourier transformer corresponds to the length of said selected multi-carrier signal of an interval longer than said one symbol.

11. The reception device for a multi-carrier signal according to claim 9, wherein the channel equalization performed by said channel compensator is conducted by multiplying equalization coefficients by the multi-carrier signal and thereby reducing the channel distortion effect of said received multi-carrier signal in the frequency region.

12. The reception device for a multi-carrier signal according to claim 9, wherein orthogonal frequency division multiplexing is employed in said multi-carrier system.

13. The reception device for a multi-carrier signal according to claim 9, wherein multi-carrier code division multiple access is employed in said multi-carrier system.

14. The reception device for a multi-carrier signal to according to claim 9, wherein said received multi-carrier signal does not contain guard intervals between adjacent symbol frames.

15. The reception device for a multi-carrier signal according to claim 10, wherein the discrete Fourier transformation of length longer than the dimensions of the multi-carrier signal is of length which is an integral multiple of the dimensions of said multi-carrier signal.

16. The reception device for a multi-carrier signal according to claim 15, wherein the estimated values of the channel response with respect to said discrete Fourier transformed output of each channel are found by interpolation of estimated values of reduced dimensions.
